(19) United States
(12) Patent Application Publication
(10) Pub. No.: US 2023/0127972 A1
(43) Pub. Date: Apr. 27, 2023

(54) IMPROVED LIFTING SURFACE

(71) Applicant: AIRBUS OPERATIONS LIMITED, Bristol (GB)

(72) Inventors: Ben COMMIS, Bristol (GB); Alexis Anthony LIBERSON, Bristol (GB); Samuel HASKEY, Bristol (GB); Olivier BLESBOIS, Bristol (GB); Meredith EVANS, Bristol (GB)

(21) Appl. No.: 17/973,100

(22) Filed: Oct. 25, 2022

(30) Foreign Application Priority Data
Oct. 27, 2021 (GB) 2115469.5

(51) Int. Cl. B64C 23/06

(52) U.S. Cl. CPC B64C 23/069

(57) ABSTRACT

A linear step discontinuity on the lower surface of the lifting surface is disclosed extending from the front of the lifting surface, possibly the leading edge, and may extend in the direction of the line of flight towards the trailing edge. The linear step discontinuity represents a step up if moving from the outboard end to the inboard end, such that in use fluid moving over the lifting surface tumbles over the linear step discontinuity to create a vortex in the fluid passing over the upper surface. The lifting surface may be an aircraft wing or in particular a winglet on an aircraft wing. The linear step discontinuity may be provided by the straight edge of a semi-circular object integrated into or adhered to the surface of the lifting surface.

### TECHNICAL FIELD

The present invention relates to lifting surfaces and more particularly to lifting surfaces for use on aircraft. The present invention provides an improved lifting surface and method of making the same.

### BACKGROUND

The minimum permissible approach speed for an aircraft will depend, at least in part, upon the stall speed and the stall characteristics of the aircraft. Typically the minimum permissible speed will be higher than the stall speed by a margin. The size of the margin will depend in part on the stall characteristics of the aircraft, those with benign stall characteristics having a lower margin than those with more difficult stall characteristics.

It is generally desirable to minimise the approach speed of an aircraft as it comes in to land. Lower speeds result in lower kinetic energy that need to be dispersed by the braking and other systems of the aircraft, and permit the use of shorter runways or provide an increased margin of error.

Accordingly by reducing the stall speed or improving the stall characteristics of an aircraft, lower approach speeds are made permissible and the performance of the aircraft is improved.

Stall is caused by flow separation, an aerodynamic phenomena where airflow over a lifting surface, such as a wing, is separated from that lifting surface and becomes turbulent. Flow separation causes the lift provided by the lifting surface to be reduced and causes increased drag. Flow separation typically starts at part of a lifting surface and may spread over the whole of the lifting surface if the conditions which caused it are not changed.

With reference to FIG. 1, an aircraft 2 is shown that has wings 4 and further comprising winglets 6, which are attached to a fuselage 8. It has been found that winglets 6 in particular tend to undergo a sudden transition into flow separation, whereby separated flow over part of the winglet quickly spreads over the whole winglet, negatively impacting the stall characteristics of the aircraft 2.

It would be desirable to modify the winglet 6 such that flow separation occurs as a more gradual event to improve the stall characteristics of aircraft 2.

### SUMMARY

A first aspect of the present invention provides a lifting surface for generating lift when moving through a fluid, wherein: the lifting surface is generally flat and comprises an upper surface and lower surface; the upper and lower surfaces meet at a front for parting the fluid to move over the upper and lower surfaces; the upper and lower surfaces meet at a trailing edge, distal from the front; and the lifting surface comprises and inboard and outboard end, distal from each other at either end of the front; further comprising: a linear step discontinuity on the lower surface, extending from the front towards the trailing edge, the step discontinuity being a step up moving from the outboard end to the inboard end, such that in use the linear step discontinuity creates a vortex in the fluid passing over the upper surface.

Preferably, the front comprises a leading edge, and the linear step discontinuity ends at the apex of the front.

Preferably, the lifting surface has a line of flight being the direction incident fluid moves relative to the lifting surface in use, wherein the linear step discontinuity is aligned with the line of flight.

Preferably, the lifting surface comprises a second like linear step discontinuity on the lower surface, further spaced apart from the first linear step discontinuity along the front towards the inboard end.

Optionally, the linear step discontinuity is provided by an edge of a thin film adhered to the lower surface.

Preferably, the thin film has a semi-circle shape, the base of the semi-circle providing the linear step discontinuity.

Advantageously, at least one edge of the thin film not providing the linear step discontinuity is blended in to the lower surface such that it does not create a linear step discontinuity.

Optionally, the lifting surface comprises an aircraft wing.

Preferably, the aircraft wing comprises a winglet and the linear step discontinuity is on the winglet.

Preferably, the winglet is a swept winglet with a substantially straight leading edge.

Optionally, the linear step discontinuity is curved.

A second aspect of the present invention provides a method for improving the low speed characteristics of a lifting surface, the lifting surface being generally flat and comprising an upper surface and lower surface; the upper and lower surfaces meeting at a front for parting the fluid to move over the upper and lower surfaces; the upper and lower surfaces meeting at a trailing edge, distal from the front; and the lifting surface comprising and inboard and outboard end, distal from each other at either end of the front; the method comprising: providing a linear step discontinuity on the lower surface, extending from the front towards the trailing edge, the step discontinuity being a step up moving from the outboard end to the inboard end.

Preferably, the step of providing the linear step discontinuity is carried out by attaching a thin film to the lower surface.

Preferably, the method further comprises a step of blending an edge of the thin film into the lower surface.

Preferably, the method further comprises providing a second like linear step discontinuity on the lower surface further towards the inboard end from the first linear step discontinuity.

Preferably, the lifting surface is a wing comprising a winglet and the step of providing a linear step discontinuity comprises providing the linear step discontinuity on the winglet.

### BRIEF DESCRIPTION OF THE DRAWINGS

Embodiments of the invention will now be described, by way of example only, with reference to the accompanying drawings, in which:

FIG. 1 is a schematic perspective view of an aircraft;

FIG. 2 is a schematic cross section view of a lifting surface;

FIG. 3 is a schematic plan view of a lifting surface from below according to an embodiment of the present disclosure;

FIG. 4 is a schematic cross section view of a lifting surface according to an embodiment of the present disclosure;

FIG. 5 is a schematic plan view of a lifting surface from above according to an embodiment of the present disclosure;

FIG. 6 is a schematic view of alternative shapes for the objects to be added to the lifting surface;

FIG. 7 is a schematic cross section view of a lifting surface;

FIG. 8a is a schematic perspective views of the underside of a lifting surface in a high angle of attack orientation; and

FIG. 8b is a schematic perspective views of the underside of a lifting surface in a low angle of attack orientation.

### DETAILED DESCRIPTION

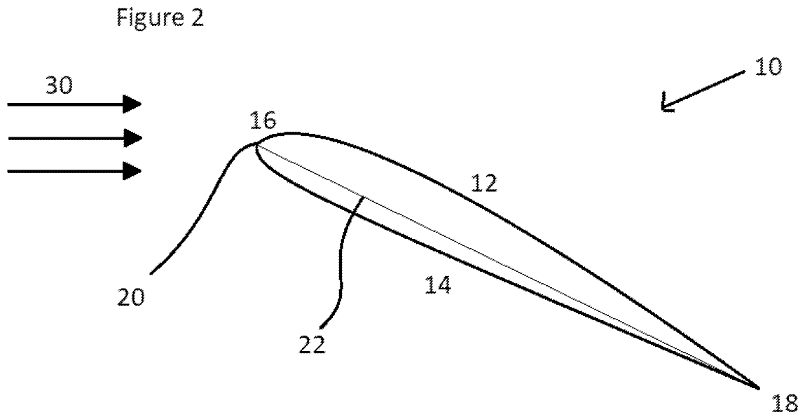

With reference to FIG. 2 the various features of a lifting surface 10 will now be described. The lifting surface 10 is designed to provide lift when moving through an incident fluid 30, the flow of which is shown by arrows. It should be understood that the fluid 30 will flow in a number of different directions in the proximity of the lifting surface 10. The term incident fluid will be used to refer specifically to the fluid 30 in the bulk away from the lifting surface 10. The direction of this incident fluid 30 is also known as the Line of Flight in the context of aeroplanes and that term will be used henceforth in this document to refer to the direction of the incident fluid 30.

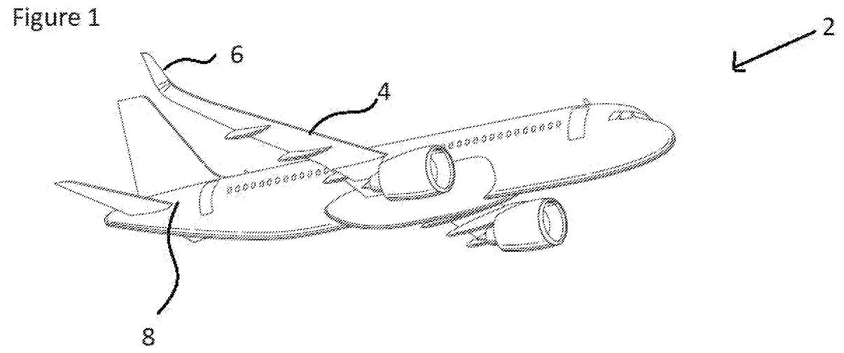

The lifting surface 10 in cross-section as shown in FIG. 2 has the shape of an aerofoil, being generally flat and having an upper surface 12 and lower surface 14. The upper and lower surfaces 12, 14 meet at the front end 16 of the lifting surface 10. The upper and lower surfaces 12, 14 also meet at a trailing edge 18, distal from the front 16, at the rear of the lifting surface 10 with reference to the flow of fluid 30. By “generally flat” it is meant that the distance between the upper surface 12 and lower surface 14 is substantially less than the distance between the front end 16 and trailing edge 18, and the upper surface 12 and lower surface 14 are generally somewhat parallel. The lifting surface 10 may also be curved in one or more directions, for example like the winglet 6 in FIG. 1.

The front 16 has a leading edge 20, which may be the part of the front that has maximum curvature. The straight line 22 that connects the leading edge 20 and the trailing edge 18 is known as the chord 22 of the aerofoil. The angle of the line of flight compared to the chord 22 is known as the angle of attack.

With reference again to FIG. 1, a wing 4 or winglet 6 may each comprise a lifting surface 10. When so mounted to an aircraft fuselage 8 the lifting surface has an inboard end where the wing 4 meets the fuselage 8 and an outboard end, distal from the inboard end, away from the fuselage 8 and at the other end of the front 16 compared to the inboard end.

In use, the fluid 30 is parted by the front 16 and moves over the upper and lower surfaces 12, 14 to generate lift. Fluid 30 passes (somewhat) smoothly over the upper and lower surfaces 12, 14. As the angle of attack of the lifting surface 10 increases or the speed of the oncoming fluid 30 decreases, the flow of fluid 30 may become separated from the upper surface 12. Although in different situations flow separation can in principle occur on any part of lifting surface 10 it is flow separation from the upper surface 12 that this invention seeks to address. Flow separation reduces the lift created by a lifting surface 10, and further may create an increase in drag experienced by the lifting surface 10. Ultimately flow separation may lead to a stall of the lifting surface 10.

Flow separation does not necessarily occur along the whole length of the upper surface 12. Rather, depending on the configuration of the lifting surface 10 flow separation may initiate at one part of the lifting surface 10, and then proceed along the length of the lifting surface 10 if conditions persist. It is generally preferable to minimise the amount of a lifting surface 10 that is experiencing flow separation, and therefore it is desirable to delay both the onset of a flow separation as well as the speed of its progression along a lifting surface 10.

One way that flow separation is often inhibited is by making the front 16 of the lifting surface 10 totally smooth, since discontinuities have been found to induce early flow separation. Furthermore significant protrusions from the lifting surface 10 such as vortilons can be used to induce turbulence into the fluid 30 moving over the upper surface 12 which inhibit the onset of flow separation.

It has surprisingly been found, however, that low profile discontinuities on particular parts of the lifting surface 10 can serve to inhibit the progression of flow separation across the lifting surface 10. Accordingly by providing one of more of these shaped discontinuities on a lifting surface 10 the speed of progression of flow separation across the lifting surface 10 can be moderated, leading to improved handling characteristics.

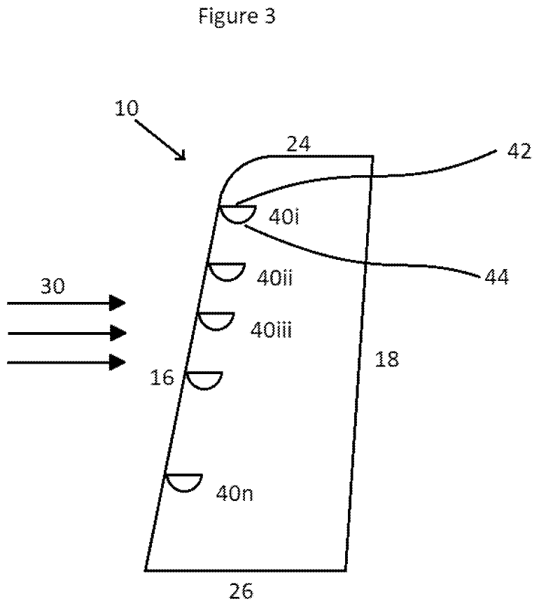

The nature of the shaped discontinuity will become more readily apparent exemplified in a first embodiment of the invention. With reference to FIG. 3, a plan view of the lower surface 14 of lifting surface 10 is shown. Labelled for clarity in this figure are the outboard end 24 and inboard end 26 of the lifting surface. In the example shown, the front 16 of the lifting surface 10 is swept rearwards towards the outboard end 24.

Provided on the lower surface 14 of the lifting surface 10 are a series of semi-circular objects 40i, 40ii, 40iii . . . 40n. Each of the semi-circular objects 40 has a straight linear base 42 and a curved edge 44. The straight linear base 42 is aligned with the line of flight 30 and extends from the leading edge towards the trailing edge along the lower surface 14 of the lifting surface 10. The curved edge 44 of the semi-circular objects 40 extends in an inboard direction 26 from the straight linear base 42.

The semi-circular objects 40 are raised with respect to the rest of the lower surface 14 of the lifting surface 10. Accordingly, the straight linear base 42 represents a step up when moving along the front 16 from the outboard end 24 to the inboard end 26. The height of the semi-circular objects is relatively low. For example, if applied to a winglet on a typical commercial airliner, the height of the semi-circular objects 40 (and accordingly the height of the step up represented by the straight linear base 42) may be in the region of 0.5 mm Alternatively, the height of the semi-circular objects 40 may be in the region of 1 mm. Further alternatively more significant heights may be appropriate in applications and the height of the semi-circular objects 40 may be in the region of 1 mm to 5 mm

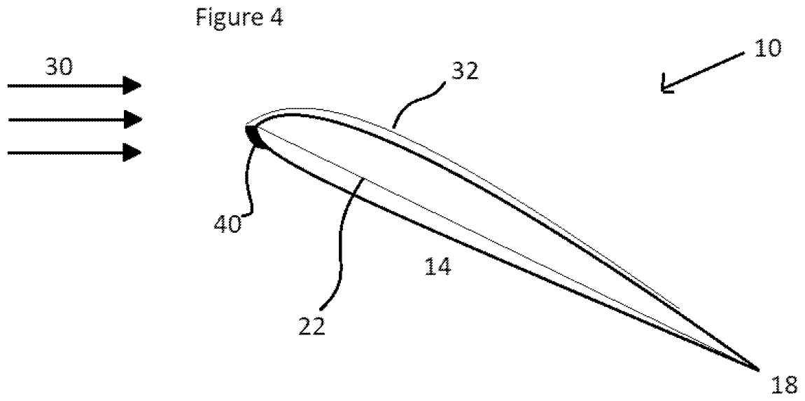

The straight linear base 42 and the step change in the surface of the lifting surface 10 created by it provides the shaped discontinuity—a linear step discontinuity. With reference to FIG. 4, a schematic cross section of a lifting surface 10 is shown similar to that of FIG. 2 but with the addition of a semi-circular object 40 in accordance with the embodiment shown in FIG. 3. For clarity some labels present in FIG. 2 are omitted from this figure but every feature of FIG. 2 is still present.

As can be seen most clearly in cross section, the semi-circular object 40 extends along the lower surface 14 of lifting surface 10 from the leading edge 20 of the frontl6 towards the trailing edge 18. At positive angles of attack that could lead to a flow separation, such as that illustrated in FIGS. 2 and 4, the flow of fluid 30 over the lifting surface 10 is disturbed by the straight linear base 42 of the semi-circular object 40. This disturbance causes a small vortex 32 to form in the fluid 30 and extend over the upper surface 12 of the lifting surface 10.

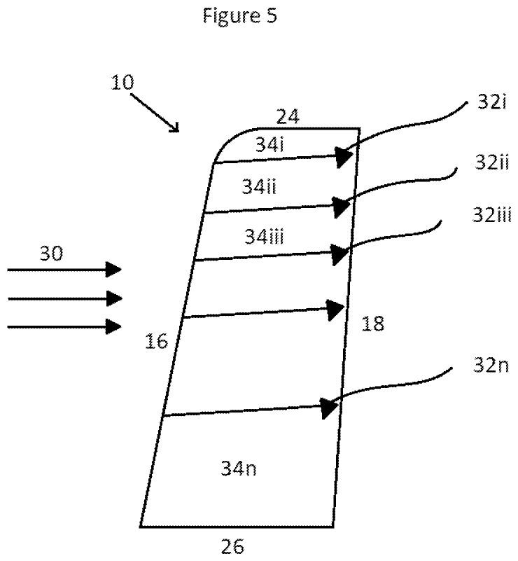

With reference to FIG. 5, the impact of the semi-circular objects 40 can be seen on the airflow over the lifting surface 10. Each semi-circular object 40i, 40ii, 40iii . . . 40n creates a corresponding vortex 32i, 32ii, 32iii . . . 32n in the fluid 30 over the upper surface 12 of the lifting surface 10. These vortices 32 create multiple flow regions 34i, 34ii, 34iii . . . 34n in the fluid 30 over the upper surface 12 of the lifting surface 10.

Typically flow separation would initiate at the outboard end 24 of the lifting surface 10, and the region of separated flow would move towards the inboard end 26. The vortex 32i servers to confine the region of flow separation at least initially in the outermost flow region 34i, the vortex 32i bounding that region 34i acting as a barrier that stops or at least slows the progression of flow separation along the lifting surface 10.

Since the vortices 32 separate the flow regions 34, even if flow separation progresses to the next flow region 34ii it again cannot progress over the whole upper surface 12 of the lifting surface 10. Accordingly the progress of flow separation over the lifting surface 10 is inhibited from quickly covering the whole lifting surface 10, instead having a more gradual progression that results in more desirable stall characteristics for the lifting surface 10.

The skilled person will realise that a lifting surface 10 according to this embodiment has desirable stall characteristics, where the progress of flow separation along the whole surface of the lifting surface 10 is inhibited.

As previously stated, the desired shaped discontinuity is provided by the straight linear base 42 of the semi-circular object 40. The curved edge 44 of the semi-circular object also represents a discontinuity on the surface of the lifting surface 10. The effect of that discontinuity is minimised by the curved shape of that edge 44. However, it is further desirable that the height of the semi-circular objects 40 is reduced towards the curved edge 44. Preferably, the curved edge 44 is blended in to the lower surface 14, such that it provides no or a very small aerodynamic discontinuity.

The semi-circular objects 40 can be provided in the form of a thin film that can be adhered to the lower surface 14 of a lifting surface 10 in order to realise the arrangement described above. Ideally, these can be in the form of self-adhesive stickers, allowing easy retrofit or replacement of the features to an existing lifting surface 10. After the thin film is applied, the curved edge 44 of the semi-circular objects 40 may be blended in to the surface of the lifting surface 10 e.g. by sanding; by applying heat to soften and even melt the curved edge 44 (where the thin film has a relatively low melting point); by using a solvent soften or blend the curved edge 44; or by applying a further substance such as a resin or paint to fill the hollow of the step created by curved edge 44.

A linear step discontinuity according to this invention could be provided in other ways than those described above. Important features of the linear step discontinuity include its shape, and its position on the lifting surface 10.

The term linear is used to denote that the discontinuity does not have kinks or sharp angles in it—it is in the form of a smooth line. Since the surface of the lifting surface 10 in the region of the front 16 and especially the leading edge 20 is highly curved, this is not a straight line in 3D space. The linear step discontinuity may be in the form of a straight line projected onto the surface of the lifting surface 10. In the first embodiment where the linear step discontinuity is provided by the base 42 of a semi-circle, for example, the base 42 may be straight when flattened i.e. if provided by a thin film adhered to the lifting surface 10, the semi-circular object 40 would have a straight base 42 before application that becomes a curved line in 3D space.

The term step is used to denote that the discontinuity is in the form in a change of height of the surface of the lifting surface 10. This may be in the form of a sharp step with a face perpendicular to the surface of the lifting surface 10, or may more gradual or smoothed out.

The linear step discontinuity is on the lower surface 14 of the lifting surface 10, extending from the front 16 towards the trailing edge 18. Preferably, one end of the linear step discontinuity terminates at the leading edge 20 of the lifting surface 10. Alternatively, the termination of the linear step discontinuity may be near the leading edge 20 or even somewhat past the leading edge 20 towards the upper surface 12 of the lifting surface 10. Depending on the length of the linear step discontinuity, it may begin and end on the curved part of the lifting surface 10 that makes up the front 16, or it may extend further along the lower surface 14 of the lifting surface 10.

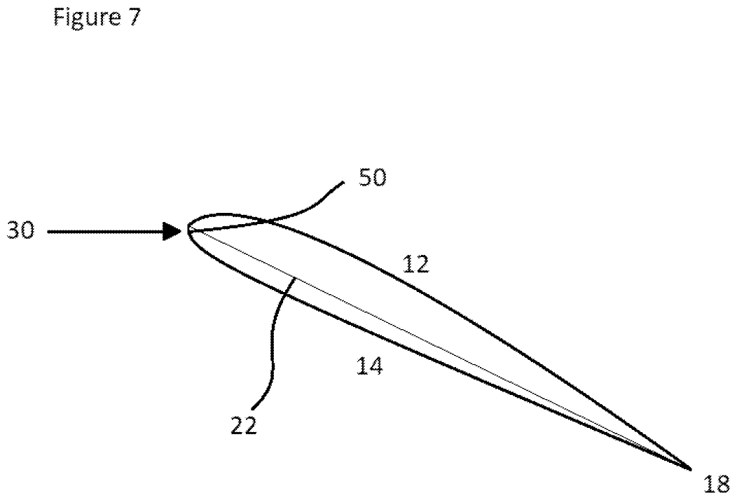

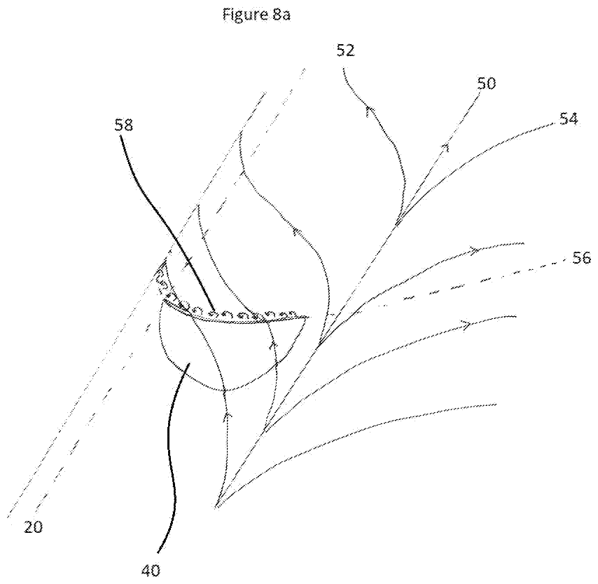

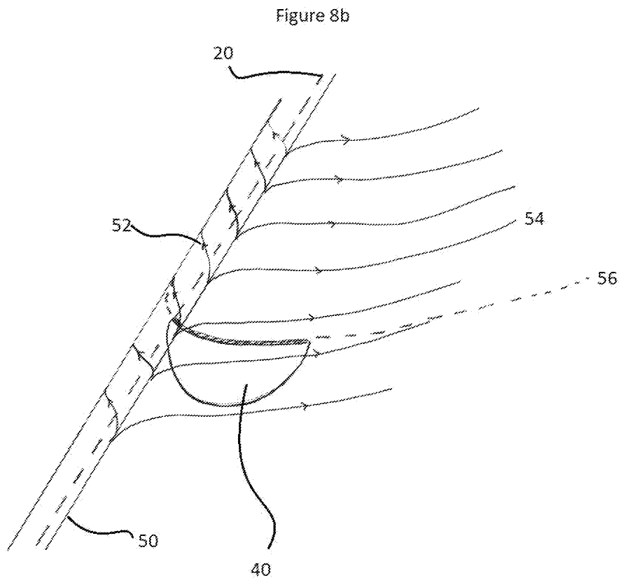

With reference to FIG. 7, the attachment point 50 is shown. This is the point on the lifting surface 10 where the incident fluid 30 attaches to the lifting surface 10 and is split to move over the upper surface 12 and lower surface 14. The attachment point 50 is distinct from the leading edge 20 and may occupy different parts of the lifting surface 10 in different flight conditions as is illustrated in FIGS. 8a and 8b.

FIG. 8a shows a perspective view of the lower surface 14 of the lifting surface 10. The leading edge 20 is indicated by a dotted line. In this figure, the lifting surface 10 is in a high angle of attack orientation. Accordingly the attachment point 50 is relatively far from the leading edge 20. The incident fluid 30 arriving at the wing splits at the attachment point 50 to either travel over the leading edge and then the upper surface 12 of the lifting surface 10, or instead to continue along the lower surface 14 of the lifting surface 10.

The direction of flow of the incident fluid 30 is illustrated with arrowed lines, showing the flow of air along the attachment point 50, the upper path 52 of the fluid and the lower path 54 of the fluid. In general the flow of fluid along the lifting surface is from the inboard end 26 to the outboard end 24 as well as splitting at the attachment point 50 to go over the upper surface 12 and lower surface 14 of the wing.

The line of flight as it intercepts the lifting surface 10 is shown by dotted line 56, and as can be seen the straight linear base 42 of the semi-circular object 40 is parallel with the line 56. The upper path 52 of the fluid crosses over the straight linear base 42, causing a micro vortex 52 which forms the start of the vortex that extends over the upper surface 12 of the lifting surface 10. The crossing of the upper path 52 and the straight linear base 42 is at a substantial angle.

FIG. 8b shows a perspective view of the lower surface 14 of the lifting surface 10 in a low angle of attack orientation. In such an orientation the attachment point 50 is much closer to the leading edge 20. Accordingly, it is the lower path 54 of the fluid which has the most interaction with the semi-circular object 40, and the lower path 54 is nearly parallel with the straight linear base 42 thereby minimising the effect of the step discontinuity on the flow of fluid over the lower surface 14 of the lifting surface 10.

Accordingly it is preferable that the linear step discontinuity be positioned on the wing so that it is substantially parallel with the local flow of fluid during low angle of attack conditions, and at a significant angle towards the inboard end 26 of the lifting surface 10 during high angle of attack conditions so as to maximise its impact on the local flow of fluid. In some embodiments this may be achieved by orienting the linear step discontinuity parallel with the line of flight. In some circumstances it may be desirable to have the linear step discontinuity at an angle to the line of flight. For example, orienting the linear step discontinuity at a an angle closer to 90 degrees to the local fluid flow during high angle of attack conditions may further improve the stall characteristics of the lifting surface. In some embodiments the linear step discontinuity may be oriented between parallel with the line of flight and at 90 degrees away from the line of flight towards the inboard end 26 of the lifting surface 10. More preferably, the linear step discontinuity should be oriented at an angle between 10 degrees and 80 degrees relative to the local flow of fluid over the lifting surface during the conditions when it is desirable to have maximum impact on the fluid flow i.e. at or around the onset of stall.

A single linear step discontinuity on a lifting surface 10 is expected to provide benefits by separating the lifting surface 10 into two flow regions 34. As shown previously, the addition of a second linear step discontinuity provides an additional flow region 34 and is expected to further improve the stall characteristics of the lifting surface 10. It may be desirable to evenly space apart the linear step discontinuities along the front 16 of the lifting surface 10 so as to even out the size of the flow regions 34.

Alternatively, regions of the lifting surface 10 likely to encounter flow separation more quickly than others may have a higher density of linear step discontinuities. Such a determination may be made, for example, by measuring the local speed of the fluid 30 moving over the upper surface 12 of the lifting surface 10, and providing an increasing density of linear step discontinuities where the local speed is lower. Alternatively measurements of the thickness of the boundary layer may be used to position the linear step discontinuities, with a higher density present where the boundary layer is thinner.

There are a variety of ways to realise the linear step discontinuity on the lifting surface 10. As previously described, discrete semi-circular objects 40 that can be adhered to the surface of the lifting surface 10 is one option, and is particularly desirable since it is amenable to retrofitting on existing lifting surface. Since the desired feature is a linear step discontinuity, however, other shapes of objects may also be suitable.

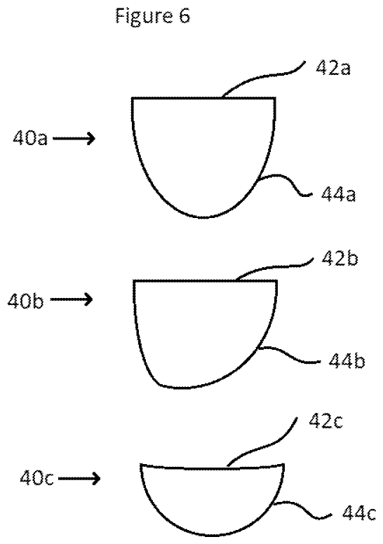

With reference to FIG. 6, variations on the semi-circular shape are now described. A semi-ellipse object 40a, having a greater distance between straight linear base 42a and a curved edge 44a might be desirable in applications to provide increased contact area for better bonding. In contrast, a semi-ellipse object with lesser distance between the straight linear base and curved edge might be desirable where sufficient bonding can be realised from even a reduced contact area.

In some applications, a skew semi-circle or semi-ellipse object 40b might be desirable, where the curved edge 44b is skewed to one side. Such a skew object 40b, skewed either towards or away from the front 16 might be desirable depending on the configuration of the lifting surface 10.

As previously mentioned, an object 40c could have a curved linear base 42c might be desirable in some applications.

Any combination of these features might be desirable depending on the circumstances. For example the curved linear base 42c of object 40c could be combined with a skew semi-circular curved edge 44b of object 40b. Furthermore a combination of differently shaped objects 40 may be desirable along the front 16 of a lifting surface 10, for example with different shapes being used for areas of different curvature.

With semi-circular objects 40, it was found that an improvement in stall characteristics was realised for the lifting surface 10 even without blending the curved edges 44 of the objects 40. However in any of the above cases it may be desirable to blend the curved edges 44 of the objects 40 to avoid features which might, for example, increase the stall speed of the lifting surface 10.

In some applications, and especially where the edges of the objects 40 that do not provide the linear step discontinuity are to be blended in to the surface of the lifting surface 10, more radically differently shaped objects may be appropriate. For example, triangular or rectangular objects could be used.

In other embodiments, the linear step discontinuity can be manufactured into the surface of lifting surface 10, without any adjacent features. For example in the case of a metallic or part-metallic lifting surface 10 the linear step discontinuity could be machined into the surface of the lifting surface 10. In the case of a lifting surface 10 made using a moulded resin, for example a resin composite material, the linear step discontinuity could be created by mould in which the lifting surface 10 is moulded. A lifting surface 10 made from Carbon Fibre Reinforced Plastic (CFRP) where the reinforcement is in the form of sheets of fabric could provide the linear step discontinuity in the underlying fabric. For example, if the lifting surface 10 is made using pre-impregnated carbon fibre sheets, the linear step discontinuity could be provided by one or more layers of the carbon fibre sheets extending from the inboard direction being cut or terminating at the location for the linear step discontinuity.

With reference again to FIG. 1, the invention was conceived with the intention of improving the stall characteristics of the winglets 6 of an aircraft 2. However, the effect of smoothing out the progress of flow separation on a lifting surface 10 may be desirable in many other applications. With respect to use on an aircraft, any other lift-providing lifting surface, such as the wings 4 may also benefit from the invention. The horizontal stabilisers or canards if present could also benefit from the introduction of linear step discontinuities. Other aircraft, such as helicopters, propeller aircraft or multi-rotors could also feature linear step discontinuities on the wings if present, stabilisers or even on the rotor or propeller.

Any other vehicle that uses a lifting surface to generate lift by exploiting motion through a fluid might benefit from the improved stall characteristics offered by this invention. For example, automobiles, trains, ground effect vehicles, spacecraft and/or sailing boats may all use lifting surface suitable for modification according to the invention. The fluid might be air as conceived initially, or another fluid. For example hydrofoils on a watercraft might benefit from the invention also.

The invention may further find applications in static installations, for example on wind turbines.

Although the invention has been described above with reference to one or more preferred examples or embodiments, it will be appreciated that various changes or modifications may be made without departing from the scope of the invention as defined in the appended claims.

Where the term “or” has been used in the preceding description, this term should be understood to mean “and/or”, except where explicitly stated otherwise.

1. A lifting surface for generating lift when moving through a fluid, wherein:
the lifting surface is generally flat and comprises an upper surface and lower surface; the upper and lower surfaces meet at a front for parting the fluid to move over the upper and lower surfaces; the upper and lower surfaces meet at a trailing edge, distal from the front; and the lifting surface comprises and inboard and outboard end, distal from each other at either end of the front; further comprising:
a linear step discontinuity on the lower surface, extending from the front towards the trailing edge, the step discontinuity being a step up moving from the outboard end to the inboard end, such that in use the linear step discontinuity creates a vortex in the fluid passing over the upper surface.

2. A lifting surface according to claim 1, wherein the front comprises a leading edge, and the linear step discontinuity ends at the leading edge of the front.

3. A lifting surface according to claim 1, the lifting surface having a line of flight being the direction incident fluid moves relative to the lifting surface in use, wherein the linear step discontinuity is aligned with the line of flight.

4. A lifting surface according to claim 1, comprising a second like linear step discontinuity on the lower surface, further spaced apart from the first linear step discontinuity along the front towards the inboard end.

5. A lifting surface according to claim 1, wherein the linear step discontinuity is provided by an edge of a thin film adhered to the lower surface.

6. A lifting surface according to claim 5, wherein the thin film has a semi-circle shape, the base of the semi-circle providing the linear step discontinuity.

7. A lifting surface according to claim 5, wherein at least one edge of the thin film not providing the linear step discontinuity is blended in to the lower surface such that it does not create a linear step discontinuity.

8. A lifting surface according to claim 1, wherein the lifting surface comprises an aircraft wing.

9. A lifting surface according to claim 8, wherein the aircraft wing comprises a winglet and the linear step discontinuity is on the winglet.

10. A lifting surface according to claim 9, wherein the winglet is a swept winglet with a substantially straight leading edge.

11. A lifting surface according to claim 1, wherein the linear step discontinuity is curved.

12. A method for improving the low speed characteristics of a lifting surface, the lifting surface being generally flat and comprising an upper surface and lower surface; the upper and lower surfaces meeting at a front for parting the fluid to move over the upper and lower surfaces; the upper and lower surfaces meeting at a trailing edge, distal from the front; and the lifting surface comprising and inboard and outboard end, distal from each other at either end of the front; the method comprising:
providing a linear step discontinuity on the lower surface, extending from the front towards the trailing edge, the step discontinuity being a step up moving from the outboard end to the inboard end.

13. A method according to claim 12, wherein the step of providing the linear step discontinuity is carried out by attaching a thin film to the lower surface.

14. A method according to claim 13, further comprising a step of blending an edge of the thin film into the lower surface.

15. A method according to claim 12, further comprising providing a second like linear step discontinuity on the lower surface further towards the inboard end from the first linear step discontinuity.

16. A method according to claim 12, wherein the lifting surface is a wing comprising a winglet and the step of providing a linear step discontinuity comprises providing the linear step discontinuity on the winglet.
